(19) United States
(12) Patent Application Publication
(10) Pub. No.: US 2014/0147748 A1
(43) Pub. Date: May 29, 2014

(54) NEGATIVE ELECTRODE MATERIAL FOR LITHIUM SECONDARY BATTERY

(71) Applicants: Koji Hisayuki, Oyama-shi (JP); Daisuke Hashimoto, Oyama-shi (JP)

(72) Inventors: Koji Hisayuki, Oyama-shi (JP); Daisuke Hashimoto, Oyama-shi (JP)

(73) Assignee: SHOWA DENKO K.K., Tokyo (JP)

(21) Appl. No.: 13/877,976

(22) PCT Filed: Oct. 11, 2011
(86) PCT No.: PCT/JP11/73320

§ 371 Date: Oct. 18, 2013

(30) Foreign Application Priority Data
Oct. 12, 2010 (JP) 2010-229342

(51) Int. Cl. H01M 4/36

(52) U.S. Cl. CPC H01M 4/366
USPC 429/218.1

(57) ABSTRACT

A lithium secondary battery negative electrode material 1 is in the form of a foil 2 or a plate, and includes a core layer 3 having electrical conductivity, and a porous layer 4 which is formed on at least one surface of the core layer 3, and which contains Al in an amount of 90 mass % or more. The porous layer 4 has a porosity of 30 to 70 vol. %. Pores 5 formed in the porous layer 4 have a pore size of 0.1 to 15 μm. The lithium secondary battery negative electrode material 1 realizes prolongation of the cycle life of a lithium secondary battery.

### TECHNICAL FIELD

The present invention relates to a negative electrode material for a lithium secondary battery, and more particularly to a negative electrode material for a non-aqueous electrolyte secondary battery, which material can reversibly occlude and release a large amount of Li ions. As used herein, the term “non-aqueous electrolyte secondary battery” encompasses a secondary battery containing a non-aqueous electrolyte (i.e., an electrolyte dissolved in an organic solvent), and a secondary battery containing a non-aqueous electrolyte such as a polymer electrolyte or a gel electrolyte.

### BACKGROUND ART

Lithium secondary batteries (e.g., a lithium ion battery and a lithium polymer battery), which have a high energy density, have been used as a main power supply for, for example, mobile communication devices or portable electronic devices. In addition, such a lithium secondary battery has become of interest as a large-scale power supply for electricity storage or a vehicle power supply.

Hitherto, the negative electrode of such a lithium secondary battery has generally been formed of any carbon material, such as graphite or low-crystallinity carbon. However, the negative electrode formed of such a carbon material exhibits low available current density and insufficient theoretical capacity. For example, graphite, which is a type of carbon material, has a theoretical capacity as low as 372 mAh/g. Thus, demand has arisen for development of a negative electrode having a higher capacity.

Meanwhile, as has been known, when a negative electrode formed of metallic Li is employed in a lithium secondary battery, high theoretical capacity is achieved. However, such a battery poses a critical problem in that a metallic Li dendrite is deposited on the negative electrode during charging, and the dendrite is grown through repeated charging/discharging and reaches the positive electrode, resulting in internal short-circuit. In addition, since the thus-deposited metallic Li dendrite has large specific surface area and thus high reaction activity, an interfacial film is formed on the surface of the dendrite from a decomposition product of a solvent having no electron conductivity, whereby the internal resistance of the battery increases, resulting in reduction of charging/discharging efficiency. Thus, a lithium secondary battery including a negative electrode formed of metallic Li exhibits low reliability and has short cycle life. Therefore, such a lithium secondary battery has not been widely put into practice.

Under these circumstances, demand has arisen for a negative electrode material formed of a substance, other than metallic Li, which has a discharge capacity greater than that of a generally used carbon material. As has been known, for example, an element such as Sn, Si, or Ag, or a nitride or oxide of such an element can occlude Li ions and can form an alloy with Li ions, and the amount of Li ions occluded therein is considerably greater than that of Li ions occluded in any carbon material.

However, in the case where a negative electrode formed of, for example, an element such as Sn, Si, or Ag, or a nitride or oxide of such an element is employed in a lithium secondary battery, when the battery is subjected to repeated charging/discharging cycles, considerable expansion and contraction of the negative electrode may occur in association with occlusion and release of Li ions, and the expansion and contraction may cause cracking or disintegration of the negative electrode. Therefore, a lithium secondary battery including a negative electrode formed of the aforementioned substance (e.g., an element such as Sn, Si, or Ag, or a nitride or oxide of such an element) exhibits reduced cycle life, and thus cannot be used as a practical battery.

In order to solve such a problem, there has been proposed a negative electrode material formed of an alloy having two or more phases, the alloy containing a metal which is likely to occlude and release Li ions, and a metal which neither occludes nor releases Li ions, wherein the latter metal is incorporated for the purpose of preventing expansion and contraction of the negative electrode during occlusion and release of Li ions, as well as cracking or disintegration of the negative electrode caused by expansion and contraction of the negative electrode.

For example, Patent Document 1 describes a negative electrode material containing a Li-ion-occluding phase a, and a phase β formed of an intermetallic compound or solid solution of an element forming the Li-ion-occluding phase α and another element, the negative electrode material having a structure produced by rapid solidification of a molten raw material having a selected composition through, for example, the atomization method or the chill roll method. Meanwhile, Patent Document 2 describes a negative electrode material formed of composite powder produced by mixing the following raw materials: component A, which is at least one element selected from the group consisting of Ag, Al, Au, Ca, Cu, Fe, In, Mg, Pd, Pt, Y, Zn, Ti, V, Cr, Mn, Co, Ni, Y, Zr, Nb, Mo, Hf, Ta, W, and rare earth elements, and component B, which is at least one element selected from the group consisting of Ga, Ge, Sb, Si, and Sn, and by subjecting the resultant mixture to mechanical alloying treatment.

Although a negative electrode formed from the negative electrode material described in Patent Document 1 or 2 exhibits high initial discharge capacity, there cannot be effectively prevented expansion and contraction of the negative electrode through repeated charging/discharging, as well as cracking or disintegration of the negative electrode caused by expansion and contraction of the negative electrode. Thus, the negative electrode material has not yet realized prolongation of the cycle life of a lithium secondary battery.

### PRIOR ART DOCUMENT

### Patent Document

Patent Document 1: Japanese Patent Application Laid-Open (kokai) No. 2001-297757
Patent Document 2: Japanese Patent Application Laid-Open (kokai) No. 2005-78999

### SUMMARY OF THE INVENTION

### Problems to be Solved by the Invention

In order to solve the aforementioned problems, an object of the present invention is to provide a negative electrode material for a lithium secondary battery, which material occludes and releases a large amount of Li ions and thus exhibits high charge/discharge capacity, which suppresses a reduction in capacity caused by repeated charging/discharging, and which realizes prolongation of the cycle life of a lithium secondary battery.

### Means for Solving the Problems

In order to achieve the aforementioned object, the prevent invention provides the following.

1) A negative electrode material for a lithium secondary battery, the material being in the form of a foil or a plate, and comprising a core layer having electrical conductivity, and a porous layer which is formed on at least one surface of the core layer, and which contains Al in an amount of 90 mass % or more, wherein the porous layer has a porosity of 30 to 70 vol. %.

2) A negative electrode material for a lithium secondary battery according to 1) above, wherein pores formed in the porous layer have a pore size of 0.1 to 15 μm.

3) A negative electrode material for a lithium secondary battery according to 1) or 2) above, wherein porous layers are formed on both surfaces of the core layer, and the total thickness of the porous layers is 70 to 90% of the overall thickness of the material.

4) A negative electrode material for a lithium secondary battery according to 1) or 2) above, wherein a porous layer is formed only on one surface of the core layer, and the thickness of the porous layer is 70 to 90% of the overall thickness of the material.

5) A negative electrode material for a lithium secondary battery according to any of 1) to 4) above, wherein the porous layer is formed of Al having a purity of 99.9 mass % or more.

6) A negative electrode material for a lithium secondary battery according to any of 1) to 5) above, wherein the porous layer has, on a surface thereof, an Al-containing oxide film having a thickness of 20 nm or less.

7) A negative electrode material for a lithium secondary battery according to any of 1) to 6) above, wherein the material forming the core layer has the same composition as the material forming the porous layer.

8) A lithium secondary battery comprising a negative electrode formed of a negative electrode material as recited in any of 1) to 7) above, wherein the negative electrode is disposed such that a porous layer faces a positive electrode of the lithium secondary battery.

### Effects of the Invention

The negative electrode material for a lithium secondary battery (hereinafter may be referred to as “lithium secondary battery negative electrode material”) described above in any of 1) to 7) is in the form of a foil or a plate, and includes a core layer having electrical conductivity, and a porous layer which is formed on at least one surface of the core layer, and which contains Al in an amount of 90 mass % or more. Therefore, a lithium secondary battery including a negative electrode formed of the negative electrode material can occlude and release a large amount of Li ions, and thus exhibits high charge/discharge capacity. Also, since the porous layer has a porosity of 30 to 70 vol. %, in the lithium secondary battery including the negative electrode formed of the negative electrode material, expansion and contraction of the negative electrode during charging/discharging are effectively reduced by means of pores contained in the porous layer. Therefore, a reduction in capacity caused by repeated charging/discharging is suppressed, and cracking or disintegration of the negative electrode, which would otherwise be caused by expansion and contraction of the negative electrode, can be effectively prevented, whereby the cycle life of the lithium secondary battery can be prolonged.

In addition, unlike the case of the negative electrode material described in Patent Document 1 or 2, when the negative electrode of the lithium secondary battery is formed from the negative electrode material of the present invention, the negative electrode material does not require a step of mixing the material with, for example, a binder or a conductive aid, and applying the mixture to a collector.

When the negative electrode of a lithium secondary battery is formed from the lithium secondary battery negative electrode material described above in 2), expansion and contraction of the negative electrode during charging/discharging of the lithium secondary battery can be further effectively reduced.

In the lithium secondary battery negative electrode material described above in 3) or 4), the thickness of a porous layer(s) is 70% or more of the overall thickness of the material. Therefore, the negative electrode material can occlude and release a larger amount of Li ions, and thus a lithium secondary battery including a negative electrode formed of the negative electrode material exhibits high charge/discharge capacity. Meanwhile, since the thickness of a porous layer(s) is 90% or less of the overall thickness of the negative electrode material, the material can attain sufficient mechanical strength. Therefore, during production of a lithium secondary battery including a negative electrode formed of the negative electrode material, breakage of the negative electrode can be prevented.

In the lithium secondary battery negative electrode material described above in 5), the porous layer is formed of Al having a purity of 99.9 mass % or more. Therefore, the negative electrode material can occlude and release a larger amount of Li ions, and thus a lithium secondary battery including a negative electrode formed of the negative electrode material exhibits high charge/discharge capacity.

In the lithium secondary battery negative electrode material described above in 6), the porous layer has, on a surface thereof, an Al-containing oxide film having a thickness of 20 nm or less. Therefore, an increase in internal resistance can be suppressed in a lithium secondary battery including a negative electrode formed of the negative electrode material.

In the lithium secondary battery negative electrode material described above in 7), the material forming the core layer has the same composition as the material forming the porous layer. Therefore, in a lithium secondary battery including a negative electrode formed of the negative electrode material, there can be prevented separation of these layers, which would otherwise occur during charging/discharging due to the difference in thermal expansion coefficient between the core layer and the porous layer.

According to the lithium secondary battery described above in 8), initial charge/discharge capacity can be increased, and a reduction in capacity caused by repeated charging/discharging can be suppressed. In addition, in the lithium secondary battery, expansion and contraction of the negative electrode during charging/discharging are reduced by means of pores contained in the porous layer. Therefore, cracking or disintegration of the negative electrode, which would otherwise be caused by expansion and contraction of the negative electrode, can be effectively prevented, and the cycle life of the lithium secondary battery can be prolonged.

### BRIEF DESCRIPTION OF THE DRAWINGS

FIG. 1 is a partially enlarged plan view of a first embodiment of the lithium secondary battery negative electrode material of the present invention.

FIG. 2 is an enlarged cross-sectional view of the lithium secondary battery negative electrode material shown in FIG. 1, wherein a middle portion of the material is omitted.

FIG. 3 illustrates the pore size of pores contained in a porous layer of the lithium secondary battery negative electrode material shown in FIGS. 1 and 2.

FIG. 4 is a partially sectioned front view of a lithium secondary battery including a negative electrode formed of the lithium secondary battery negative electrode material shown in FIGS. 1 and 2.

FIG. 5 is an enlarged cross-sectional view of a second embodiment of the lithium secondary battery negative electrode material of the present invention, wherein a middle portion of the material is omitted.

FIG. 6 is a cross-sectional view of a lithium secondary battery including a negative electrode formed of the lithium secondary battery negative electrode material shown in FIG. 5.

### DESCRIPTION OF REFERENCE NUMERALS

(1), (20): negative electrode material for lithium secondary battery
(2): foil
(3): core layer
(4): porous layer
(5): pore
(10), (30): lithium secondary battery
(12), (32): negative electrode
(13), (33): positive electrode

### MODES FOR CARRYING OUT THE INVENTION

Embodiments of the present invention will next be described with reference to the drawings.

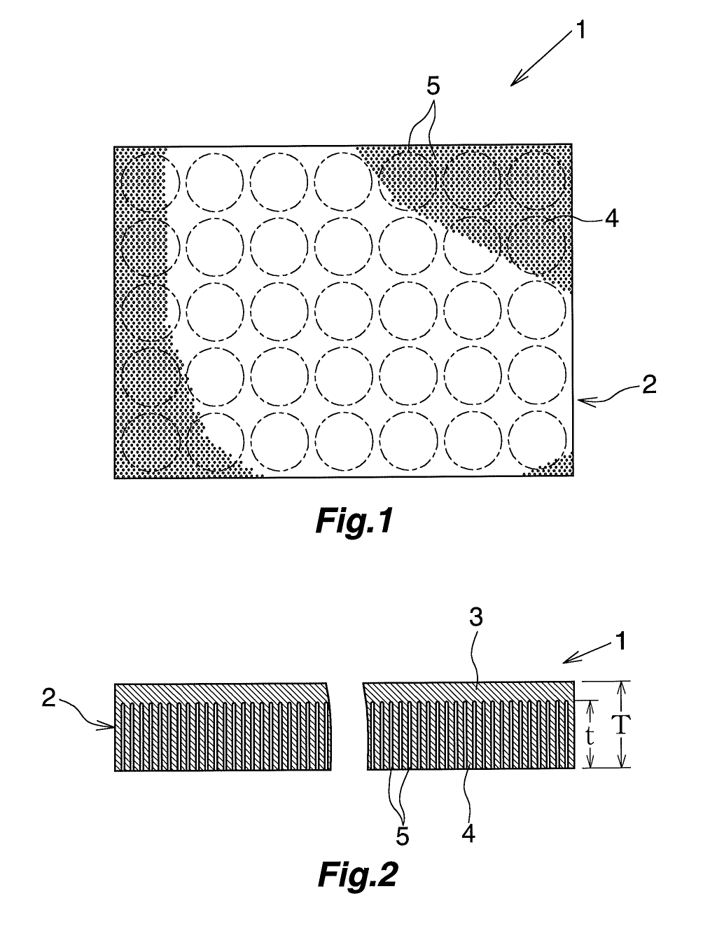

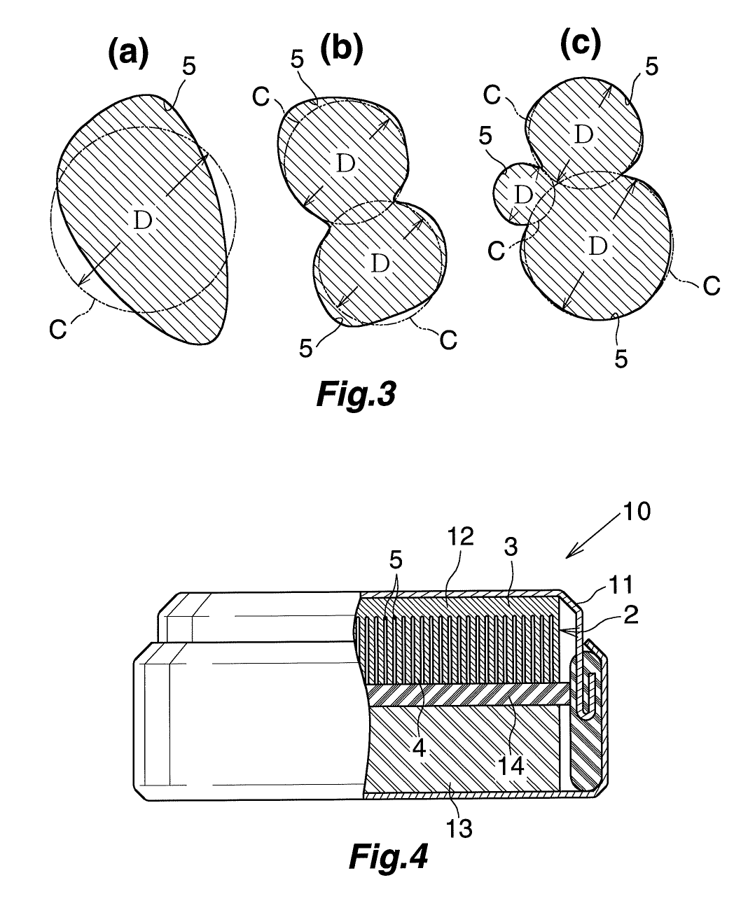

FIGS. 1 and 2 show a first embodiment of the lithium secondary battery negative electrode material of the present invention. FIG. 3 shows pores contained in the porous layer of the lithium secondary battery negative electrode material shown in FIG. 1. FIG. 4 shows an example of a lithium secondary battery including a negative electrode formed of the lithium secondary battery negative electrode material shown in FIGS. 1 and 2.

As shown in FIGS. 1 and 2, the lithium secondary battery negative electrode material (1) includes a core layer (3) having electrical conductivity, and a porous layer (4) which is formed on one surface of the core layer (3) and contains Al in an amount of 90 mass % or more, and the negative electrode material (1) is in the form of a foil (2) or a plate. As specified by JIS, the foil (2) has a thickness of 0.006 to 0.2 mm. As used herein, a “plate” has a thickness greater than that of the foil.

When the porous layer (4) of the lithium secondary battery negative electrode material (1) contains Al in an amount of 90 mass % or more, occurrence of short-circuit can be prevented between the negative electrode and the positive electrode. That is, when the porous layer (4) contains Al in an amount of less than 90 mass %, a large amount of ions of a metal other than Al are eluted from the negative electrode material (1) during charging/discharging, and a relatively large amount of the metal is formed from the metal ions and electrons during electron migration, which causes short-circuit between the negative electrode and the positive electrode.

The porous layer (4) of the lithium secondary battery negative electrode material (1) has a porosity of 30 to 70 vol. %. The porosity of the porous layer (4) is determined to be 30 to 70 vol. % in consideration of alloying of Al and Li at 1:1. Generally, a lithium secondary battery is charged at about 80%. In such a case, when the porosity is 30 vol. % or more, the volume expansion of a negative electrode formed of the negative electrode material (1) can be effectively reduced during charging, and thus cracking or disintegration of the negative electrode can be effectively prevented. Therefore, the lower limit of the porosity of the porous layer (4) must be adjusted to 30 vol. %. However, in the case of a lithium secondary battery which is generally fully charged, the porosity of the porous layer (4) is preferably adjusted to 50 vol. % or more, so as to effectively reduce the volume expansion of a negative electrode formed of the negative electrode material (1) during charging. In contrast, when the porosity of the porous layer (4) exceeds 70 vol. %, the porous layer may fail to maintain its shape, resulting in disintegration of the negative electrode material. Therefore, the upper limit of the porosity of the porous layer (4) must be adjusted to 70 vol. %.

The porosity of the porous layer (4) is determined as follows. Specifically, a cross section of the lithium secondary battery negative electrode material (1) is observed under, for example, a microscope capable of length measurement, to thereby determine the thickness of each of the porous layer (4) and the core layer (3) of the negative electrode material. Separately, the density of the material forming each of the porous layer (4) and the core layer (3) is determined on the basis of the composition of the material. The lithium secondary battery negative electrode material (1) having a specific area is provided and weighed, and the porosity of the porous layer (4) is determined by use of the below-described formulas.

In the below-described formulas, “V” represents porosity (%); “A” the area of the weighed lithium secondary battery negative electrode material (1); “M” the weight of the lithium secondary battery negative electrode material (1); “P” the density of the material forming the core layer (3); “T” the thickness of the core layer (3); “P1” the density of the material forming the porous layer (4); and “T1” the thickness of the porous layer (4). When “M1” represents the weight of the porous layer (4), and “M2” represents the weight of the porous layer (4) assuming that the porous layer (4) has no pores, the following relations are obtained:

M1=M−P×T×A

M2=P1×T1×A

Therefore, the aforementioned porosity V (%) is determined by the following formula: V={1−(M1/M2)}×100.

The thickness (t) of the porous layer (4) of the lithium secondary battery negative electrode material (1) is preferably 70 to 90% of the overall thickness (T) of the foil (2). When the thickness (t) of the porous layer (4) of the negative electrode material (1) is less than 70% of the overall thickness (T), the amount of occluded and released Li ions may be reduced, and a lithium secondary battery including a negative electrode formed of the negative electrode material (1) may fail to exhibit sufficient charge/discharge capacity. In contrast, when the thickness (t) of the porous layer (4) of the negative electrode material (1) exceeds 90% of the overall thickness (T), the thickness of the core layer (3) becomes insufficient, and the negative electrode material (1) exhibits lowered mechanical strength. Thus, during production of a lithium secondary battery including a negative electrode formed of the negative electrode material (1), the negative electrode may be broken.

The pores (5) formed in the porous layer (4) of the lithium secondary battery negative electrode material (1) have a pore size of preferably 0.1 to 15 μm, more preferably 0.1 to 5 μm, so as to facilitate incorporation of an electrolyte (e.g., LiClO₄ or LiF₆) into the pores (5). In many cases, the pores (5) do not have a circular shape in plan view. Therefore, as shown in FIG. 3(a), the term “pore size” of a pore (5) refers to the circle-equivalent diameter of the pore (5); i.e., the diameter (D) of a circle (C) having the same area as that of the pore (5). In some cases, a plurality of pores (5) are bonded together in the porous layer (4). In such a case, as shown in FIGS. 3(b) and 3(c), the “pore size” of each of the bonded pores (5) refers to the circle-equivalent diameter of the pore (5); i.e., the diameter (D) of a circle (C) having the same area as that of the pore (5).

The thickness of an Al-containing oxide film formed on the surface of the porous layer 4 is preferably 20 nm or less. When the thickness of the oxide film is excessively large, a lithium secondary battery including a negative electrode formed of the negative electrode material (1) may exhibit considerably high internal resistance. The oxide film preferably has a smaller thickness. Although the thickness of the oxide film is preferably zero (i.e., no oxide film is formed on the porous layer), expensive equipment capable of maintaining a non-oxygen atmosphere is required for preventing oxide film formation. However, when the thickness of the oxide film is to be adjusted to 20 nm or less, the aforementioned expensive equipment is not required, and a considerable increase in internal resistance of the lithium secondary battery can be suppressed even during formation of an SEI (solid electrolyte interface) required for occlusion and release of Li ions.

Preferably, the porous layer (4) of the lithium secondary battery negative electrode material (1) is formed of Al having a purity of 99.9 mass % or more, so as to increase the amount of Li ions which are occluded and released. In such a case, the initial charge/discharge capacity of a lithium secondary battery including a negative electrode formed of the negative electrode material (1) can be increased, and a reduction in capacity caused by repeated charging/discharging can be suppressed.

The foil (2) forming the lithium secondary battery negative electrode material (1), which includes the core layer (3) and the porous layer (4), may be produced through, for example, a method including a first etching treatment step of subjecting one surface of an Al foil having a purity of 99.9 mass % or more to direct current etching in an aqueous solution containing hydrochloric acid (2 to 15 mass %) and at least one acid selected from the group consisting of sulfuric acid, oxalic acid, and phosphoric acid (0.01 to 5 mass %); an intermediate treatment step of electrochemically or chemically forming a surface oxide film in an aqueous solution containing NH₄⁺ or Na⁺ (this step is carried out once or more); and a second etching treatment step of performing direct current etching in an aqueous solution containing at least one neutral salt selected from among Cl⁻-containing neutral salts (e.g., sodium chloride, ammonium chloride, and potassium chloride) (0.1 to 10 mass %).

Alternatively, the foil (2) forming the lithium secondary battery negative electrode material (1), which includes the core layer (3) and the porous layer (4), may be produced through, for example, a method in which the porous layer (4) is formed by thermal spraying or vapor deposition of Al having a purity of 99.9 mass % or more onto one surface of the core layer (3) formed of an electrically conductive material.

As shown in FIG. 4, the negative electrode material (1) is employed in, for example, a coin-type lithium secondary battery (10). The coin-type lithium secondary battery (10) includes, in a casing (11), a negative electrode (12) formed of the negative electrode material (1); a positive electrode (13) provided so as to face the negative electrode (12); a separator (14) sandwiched between the negative electrode (12) and the positive electrode (13); and a non-aqueous electrolyte (not illustrated).

As shown by dashed lines in FIG. 1, negative electrodes (12) having a specific size are formed through punching of the lithium secondary battery negative electrode material (1). In the coin-type lithium secondary battery, the negative electrode is provided such that the porous layer (4) faces the positive electrode (13) via the separator (14).

The positive electrode (13) is formed of, for example, metallic Li, but the material forming the positive electrode (13) is not limited thereto.

In the aforementioned lithium secondary battery (10), during charging, the negative electrode (12) would otherwise expand through occlusion of Li ions in the negative electrode (12) and formation of a Li-ion-containing compound, but a change in volume of the negative electrode (12) is suppressed by means of the pores (5) of the porous layer (4). Meanwhile, during discharging, the negative electrode (12) would otherwise contract through release of Li ions from the Li-ion-containing compound, but a change in volume of the negative electrode (12) is suppressed by means of the pores (5) of the porous layer (4). Therefore, cracking or disintegration of the negative electrode (12), which would otherwise be caused by expansion and contraction during charging/discharging, can be effectively prevented, and thus degradation of the negative electrode (12) is prevented, whereby the cycle life of the lithium secondary battery can be prolonged.

In addition, the initial charge/discharge capacity of the lithium secondary battery (10) is increased, and a reduction in capacity caused by repeated charging/discharging is suppressed.

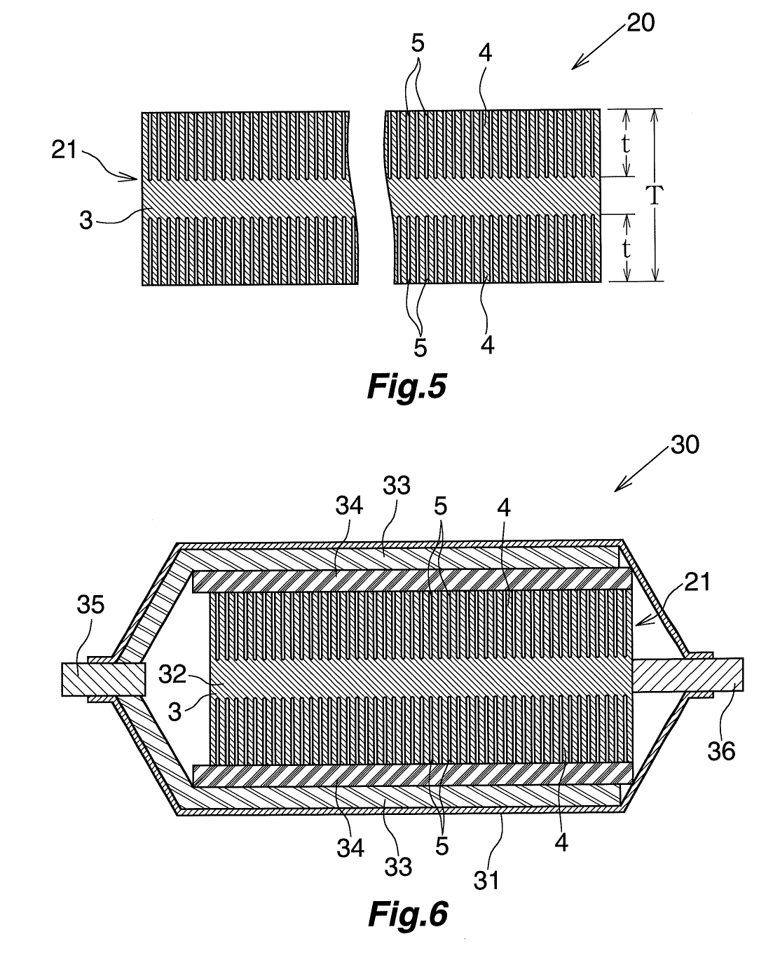

FIG. 5 shows a second embodiment of the lithium secondary battery negative electrode material of the present invention.

As shown in FIG. 5, the lithium secondary battery negative electrode material (20) includes a core layer (3) having electrical conductivity, and porous layers (4) which are formed on both surfaces of the core layer (3) and contain Al in an amount of 90 mass % or more, and the negative electrode material (20) is in the form of a foil (21) or a plate. As specified by JIS, the foil (21) has a thickness of 0.006 to 0.2 mm. As used herein, a “plate” has a thickness greater than that of the foil.

The porosity of each of the porous layers (4) of the lithium secondary battery negative electrode material (20), the pore size of pores (5) formed in the porous layer (4), and the thickness of an Al-containing oxide film formed on the surface of the porous layer (4) are the same as in the case of the lithium secondary battery negative electrode material (1) of the first embodiment.

The total thickness (2t) of the porous layers (4) (each having a thickness (t)) of the lithium secondary battery negative electrode material (20) is preferably 70 to 90% of the overall thickness (T) of the foil (21). When the total thickness (2t) of the porous layers (4) (each having a thickness (t)) of the negative electrode material (20) is less than 70% of the overall thickness (T), the amount of occluded and released Li ions may be reduced, and a lithium secondary battery including a negative electrode formed of the negative electrode material (20) may fail to exhibit sufficient charge/discharge capacity. In contrast, when the total thickness (2t) of the porous layers (4) (each having a thickness (t)) of the negative electrode material (20) exceeds 90% of the overall thickness (T), the thickness of the core layer (3) becomes insufficient, and the negative electrode material (20) exhibits lowered mechanical strength. Thus, during production of a lithium secondary battery including a negative electrode formed of the negative electrode material (20), the negative electrode may be broken.

As shown in FIG. 6, the negative electrode material (20) is employed in, for example, a laminate-type lithium secondary battery (30). The laminate-type lithium secondary battery (30) includes, in a casing (31), a negative electrode (32) formed of the negative electrode material (20); positive electrodes (33) each being provided so as to face the negative electrode (32); separators (34) each being sandwiched between the negative electrode (32) and the corresponding positive electrode (33); a minus terminal (35) which is electrically connected to the core layer (3) of the negative electrode (32) and which partially projects to the outside of the casing (31); a plus terminal (36) which is electrically connected to the positive electrodes (33) and which partially projects to the outside of the casing (31); and a non-aqueous electrolyte (not illustrated).

In the laminate-type lithium secondary battery (30), charging/discharging is carried out in the same manner as in the aforementioned coin-type lithium secondary battery (10).

Next will be described a specific example of the present invention and a comparative example.

### Example

A high-purity annealed aluminum foil (purity: 99.9 mass %, thickness: 100 μm) was provided and subjected to a first etching treatment; i.e., direct current etching through application of a DC current (current density: 20 A/dm²) for 90 seconds in a 80° C. aqueous solution containing hydrochloric acid (7 mass %) and sulfuric acid (0.1 mass %). Thereafter, the high-purity annealed aluminum foil was subjected to an intermediate treatment; i.e., immersion in a 90° C. aqueous solution containing ammonium formate (0.1 mass %) for 40 seconds (this treatment was carried out once). Subsequently, the high-purity annealed aluminum foil was subjected to a second etching treatment; i.e., direct current etching through application of a DC current (current density: 10 A/dm²) for 320 seconds in a 80° C. aqueous solution containing sodium chloride (5 mass %). Thus, a lithium secondary battery negative electrode material was produced.

The surface of the thus-produced lithium secondary battery negative electrode material was observed under a scanning electron microscope. As a result, the core layer of the negative electrode material was found to have, on both surfaces thereof, porous layers each containing numerous micropores. Each porous layer was found to have a porosity of 50%; the micropores were found to have a pore size of 0.1 to 15 μm; the total thickness of the porous layers was found to be 80% of the overall thickness of the negative electrode material; and an Al-containing oxide film formed on the surface of each porous layer was found to have a thickness of 10 nm or less.

Subsequently, a negative electrode was formed through punching of the above-produced lithium secondary battery negative electrode material by means of a circular punch (1 cm²). A positive electrode formed of metallic Li was provided, and a separator formed of polyethylene having a micropore structure (porosity: 40 vol. %) was sandwiched between the positive electrode and the negative electrode. There was provided, as an electrolyte, a solution prepared by dissolving LiPF₆ (1 mol/L) in a solvent mixture of ethylene carbonate (EC) and dimethyl carbonate (DMC) (EC:DMC=1:1 by volume). A coin-type model battery (CR2032 type) was produced from these components in a dry box in an atmosphere having a dew point of −50° C. or lower.

### Comparative Example

A negative electrode was formed through punching of a high-purity annealed aluminum foil (purity: 99.9 mass %, thickness: 100 μm) by means of a circular punch (1 cm²). A positive electrode formed of metallic Li was provided, and a separator formed of polyethylene having a micropore structure (porosity: 40 vol. %) was sandwiched between the positive electrode and the negative electrode. There was provided, as an electrolyte, a solution prepared by dissolving LiPF₆ (1 mol/L) in a solvent mixture of ethylene carbonate (EC) and dimethyl carbonate (DMC) (EC:DMC=1:1 by volume). A coin-type model battery (CR2032 type) was produced from these components in a dry box in an atmosphere having a dew point of −50° C. or lower.

### Evaluation Test

The negative electrode of each of the model batteries produced in the Example and the Comparative Example was evaluated through the following method.

Each model battery was subjected to repeated charging/discharging cycles, each cycle consisting of constant-current charging at 0.2 mA/cm² until attainment of 1 V, followed by 10 minutes rest, and then constant-current discharging at 0.2 mA/cm² until attainment of 0 V. The discharge capacity of the model battery was determined after a specific number of cycles.

Table 1 shows the evaluation results of the model batteries produced in the Example and the Comparative Example (the number of cycles, and the discharge capacity corresponding thereto).

TABLE 1

| | Discharge capacity (mAh/g) | | |
|---|---|---|---|
| | After | After | After |
| | 1 cycle | 20 cycles | 100 cycles |
| Example | 742 | 491 | 385 |
| Comparative Example | 132 | 51 | 18 |

As is clear from Table 1, the model battery produced in the Example exhibited an initial discharge capacity higher than that of the model battery produced in the Comparative Example, and the discharge capacity of the model battery of the Example was maintained at a sufficient level even after 100 cycles (i.e., a reduction in discharge capacity was suppressed). Thus, the cycle life of the model battery produced in the Example was prolonged, as compared with the case of the model battery produced in the Comparative Example.

### INDUSTRIAL APPLICABILITY

The lithium secondary battery negative electrode material of the present invention is suitable for use in a negative electrode of a lithium secondary battery, and realizes prolongation of the cycle life of the lithium secondary battery.

1. A negative electrode material for a lithium secondary battery, the material being in the form of a foil or a plate, and comprising a core layer having electrical conductivity, and a porous layer which is formed on at least one surface of the core layer, and which contains Al in an amount of 90 mass % or more, wherein the porous layer has a porosity of 30 to 70 vol. %.

2. A negative electrode material for a lithium secondary battery according to claim 1, wherein pores formed in the porous layer have a pore size of 0.1 to 15 μm.

3. A negative electrode material for a lithium secondary battery according to claim 1, wherein porous layers are formed on both surfaces of the core layer, and the total thickness of the porous layers is 70 to 90% of the overall thickness of the material.

4. A negative electrode material for a lithium secondary battery according to claim 1, wherein a porous layer is formed only on one surface of the core layer, and the thickness of the porous layer is 70 to 90% of the overall thickness of the material.

5. A negative electrode material for a lithium secondary battery according to any claim 1, wherein the porous layer is formed of Al having a purity of 99.9 mass % or more.

6. A negative electrode material for a lithium secondary battery according to claim 1, wherein the porous layer has, on a surface thereof, an Al-containing oxide film having a thickness of 20 nm or less.

7. A negative electrode material for a lithium secondary battery according to claim 1, wherein the material forming the core layer has the same composition as the material forming the porous layer.

8. A lithium secondary battery comprising a negative electrode formed of a negative electrode material as recited in claim 1, wherein the negative electrode is disposed such that a porous layer faces a positive electrode of the lithium secondary battery.

9. A negative electrode material for a lithium secondary battery according to claim 2, wherein porous layers are formed on both surfaces of the core layer, and the total thickness of the porous layers is 70 to 90% of the overall thickness of the material.

10. A negative electrode material for a lithium secondary battery according to claim 2, wherein a porous layer is formed only on one surface of the core layer, and the thickness of the porous layer is 70 to 90% of the overall thickness of the material.

11. A negative electrode material for a lithium secondary battery according to claim 2, wherein the porous layer is formed of Al having a purity of 99.9 mass % or more.

12. A negative electrode material for a lithium secondary battery according to claim 3, wherein the porous layer is formed of Al having a purity of 99.9 mass % or more.

13. A negative electrode material for a lithium secondary battery according to claim 4, wherein the porous layer is formed of Al having a purity of 99.9 mass % or more.

14. A negative electrode material for a lithium secondary battery according to claim 2, wherein the porous layer has, on a surface thereof, an Al-containing oxide film having a thickness of 20 nm or less.

15. A negative electrode material for a lithium secondary battery according to claim 3, wherein the porous layer has, on a surface thereof, an Al-containing oxide film having a thickness of 20 nm or less.

16. A negative electrode material for a lithium secondary battery according to claim 4, wherein the porous layer has, on a surface thereof, an Al-containing oxide film having a thickness of 20 nm or less.

17. A negative electrode material for a lithium secondary battery according to claim 2, wherein the material forming the core layer has the same composition as the material forming the porous layer.

18. A negative electrode material for a lithium secondary battery according to claim 3, wherein the material forming the core layer has the same composition as the material forming the porous layer.

19. A lithium secondary battery comprising a negative electrode formed of a negative electrode material as recited in claim 2, wherein the negative electrode is disposed such that a porous layer faces a positive electrode of the lithium secondary battery.

20. A lithium secondary battery comprising a negative electrode formed of a negative electrode material as recited in claim 3, wherein the negative electrode is disposed such that a porous layer faces a positive electrode of the lithium secondary battery.
